(19) United States
(12) Patent Application Publication
(10) Pub. No.: US 2024/0399521 A1
(43) Pub. Date: Dec. 5, 2024

(54) DEDICATED DUST EXTRACTOR

(71) Applicant: MILWAUKEE ELECTRIC TOOL CORPORATION, Brookfield, WI (US)

(72) Inventors: Ian McConeghy, Mequon, WI (US); Bryan C. Kendall, Lisbon, WI (US); Jeffery D. Spraggon, Pewaukee, WI (US); Randall J. Klotka, Grafton, WI (US)

(21) Appl. No.: 18/675,693

(22) Filed: May 28, 2024

Related U.S. Application Data
(60) Provisional application No. 63/519,630, filed on Aug. 15, 2023.
(60) Provisional application No. 63/505,021, filed on May 30, 2023.

(51) Int. Cl. B23Q 11/00

(52) U.S. Cl. CPC B23Q 11/0071; B23Q 11/0046

(57) ABSTRACT

A power tool assembly including a power tool and a dust extractor. The power tool includes an output chuck, a housing, a motor, and a fan. The output chuck is configured to receive a tool bit for performing a working operation and defines an output axis. The housing defines a suction inlet. The motor is disposed within the housing and defines a drive axis. The fan is rotationally driven by the motor and is configured to induce a flow of suctioning air through the suction inlet. The dust extractor is removably coupled to the power tool and includes a tool connection tube that interfaces with the suction inlet when the dust extractor is connected to the power tool. The flow of suctioning air induced by the fan flows from the dust extractor to the power tool in a direction extending parallel to the output axis.

### CROSS-REFERENCE TO RELATED APPLICATIONS

This application claims priority to U.S. Provisional Application No. 63/519,630, filed Aug. 15, 2023, which claims priority to U.S. Provisional Application No. 63/505,021, filed May 30, 2023, the entire contents of each of which are incorporated by reference herein.

### FIELD OF THE INVENTION

The present invention relates to power tools, and more particularly to dust collectors for use with power tools.

### BACKGROUND OF THE INVENTION

Dust collectors are typically used in tandem with hand-held drilling tools such as rotary hammers to collect dust and other debris during a drilling operation to prevent dust and other debris from accumulating at a worksite. Such dust collectors may be attached to a rotary hammer to position a suction inlet of the collector proximate a drill bit attached to the rotary hammer. Such dust collectors may also include an on-board dust container in which dust and other debris is accumulated. Such dust containers are often removable from the dust collector to facilitate disposal of the accumulated dust and debris.

### SUMMARY OF THE INVENTION

In one aspect, the techniques described herein relate to a power tool assembly including a power tool and a dust extractor. The power tool includes an output chuck, a housing, a motor, and a fan. The output chuck is configured to receive a tool bit for performing a working operation and defines an output axis. The housing defines a suction inlet. The motor is disposed within the housing and defines a drive axis. The fan is rotationally driven by the motor and is configured to induce a flow of suctioning air through the suction inlet. The dust extractor is removably coupled to the power tool and includes a tool connection tube that interfaces with the suction inlet when the dust extractor is connected to the power tool. The flow of suctioning air induced by the fan flows from the dust extractor to the power tool in a direction extending parallel to the output axis.

In some aspects, the techniques described herein relate to a power tool assembly, wherein the output axis and the drive axis are perpendicular.

In some aspects, the techniques described herein relate to a power tool assembly, wherein the dust extractor includes a filter, and wherein the filter is disposed at an oblique angle relative to the output axis and the drive axis.

In some aspects, the techniques described herein relate to a power tool assembly, wherein the power tool further includes a transmission assembly having an intermediate shaft extending along a transmission axis, and wherein the transmission axis extends parallel to the output axis and is positioned below the output axis.

In some aspects, the techniques described herein relate to a power tool assembly, wherein one of the power tool and the dust extractor includes a latch mechanism having a pivotable latch, and the other of the power tool and the dust extractor includes a slot for receiving the latch to couple the power tool and the dust extractor together.

In some aspects, the techniques described herein relate to a power tool assembly, wherein the latch mechanism further includes a spring and a button, the spring biasing the latch into a locked position, the button pressable to adjust the latch to an unlocked position.

In some aspects, the techniques described herein relate to a power tool assembly, wherein the fan includes a first fan portion that is configured to induce a flow of cooling air to enter the housing at an air inlet formed in the housing and configured to blow the flow of cooling air out of the housing through a vent formed in the housing, and wherein the flow of cooling air travels from the air inlet to the vent in a first direction along the drive axis.

In some aspects, the techniques described herein relate to a power tool assembly, wherein the fan includes a second fan portion that is configured to induce a flow of suctioning air to enter the housing through the suction inlet and configured to blow the flow of suctioning air out of the vent, wherein the flow of suctioning air travels from the suction inlet to the vent in a second direction along the drive axis, and wherein the first direction and the second direction are opposite directions.

In another aspects, the techniques described herein relate to a power tool assembly including a power tool and a dust extractor. The power tool includes an output chuck, a tool housing, a motor, and a fan. The output chuck is configured to receive a tool bit for performing a working operation and defines an output axis. The tool housing includes a suction conduit that defines a suction inlet. The motor is disposed within the housing and has an output shaft defining a drive axis. The fan is rotationally driven by the motor and is configured to induce a flow of suctioning air through the suction inlet. The dust extractor is removably coupled to the power tool and includes an outlet that is configured to engage the suction inlet such that the fan of the power tool induces the flow of suctioning air through the dust extractor. The dust extractor further includes a dust extractor housing and a tool connection tube. The dust extractor housing has a front end and rear end. The tool connection tube defines the outlet of the dust extractor and is configured to engage with the suction inlet of the power tool. A portion of the tool connection tube extends parallel to the output axis and protrudes from a wall of the dust extractor housing. The dust extractor is configured to be attached to the tool housing of the power tool by sliding the dust extractor in a front-to-rear direction until the tool connection tube engages with the suction inlet.

In some aspects, the techniques described herein relate to a power tool assembly, wherein the suction inlet includes an insulator, and wherein the outlet engages the insulator when the dust extractor is coupled to the power tool such that the insulator inhibits suctioning air from leaking from the power tool assembly at a point of connection between the power tool and the dust extractor.

In some aspects, the techniques described herein relate to a power tool assembly, wherein one of the power tool and the dust extractor includes a latch mechanism having a pivotable latch and a spring that biases the pivotable latch into a locked position, and the other of the power tool and the dust extractor includes a slot for receiving the latch to couple the power tool and the dust extractor together.

In some aspects, the techniques described herein relate to a power tool assembly, wherein attachment of the dust extractor to the power tool includes sliding a top surface of the rear housing portion of the dust extractor along a bottom surface of the suction conduit in a front-to-rear direction such that the bottom surface of the suction conduit moves the pivotable latch against a bias of the spring, and wherein the spring biases the pivotable latch into the slot after the pivotable latch reaches the slot during the sliding.

In some aspects, the techniques described herein relate to a power tool assembly, wherein the dust extractor further includes a rubber grommet that protrudes from the dust extractor housing to engage the tool housing of the power tool when the power tool and the dust extractor are coupled together, the rubber grommet configured to inhibit relative shaking between the power tool and the dust extractor.

In another aspect, the techniques described herein relate to a dust extractor configured to be removably attached to a power tool. The dust extractor includes: a housing, a dust box, a suction tube, a suction head, a tool connection tube, an outlet, and a filter. The dust box is pivotably connected to the housing. The suction tube is slidable into and out of the housing along a longitudinal axis extending in a front-to-rear direction. The suction head is positioned at a forward end of the suction tube and defines a first end of a flow path such that suctioning air is configured to flow into the dust extractor at the suction head. The tool connection tube is supported within the housing. A portion of the tool connection tube protrudes from a wall of the housing and extends in the front-to-rear direction parallel to the suction tube. The outlet is positioned at a rearward end of the tool connection tube and defines a second end of the flow path such that suctioning air is configured to flow out of the dust extractor at the outlet. The filter is positioned along the flow path between the suction tube and the tool connection tube. The filter is configured to separate dust and debris from suctioning air traveling along the flow path. The filter is disposed at an oblique angle relative to the longitudinal axis.

In some aspects, the techniques described herein relate to a dust extractor, wherein the suction tube is configured to be extended relative to the housing along an extension direction, and wherein the portion of the tool connection tube that protrudes from the wall of the housing extends parallel to the extension direction.

In some aspects, the techniques described herein relate to a dust extractor, wherein the filter is oriented at a 45-degree angle relative to an extension direction of the suction tube.

In some aspects, the techniques described herein relate to a dust extractor, further including a dust box connection tube positioned within the housing between the suction tube and the dust box, the dust box connection tube extending below the suction tube and parallel to the suction tube.

In some aspects, the techniques described herein relate to a dust extractor, wherein the dust box connection tube includes a 90-degree turn at a connection point with the suction tube and a 90-degree turn at a connection point with the dust box.

In some aspects, the techniques described herein relate to a dust extractor, wherein the dust box that supports at least a portion of the filter, and wherein the dust box connection tube directs the flow of air from the suction tube into the dust box.

In some aspects, the techniques described herein relate to a dust extractor, wherein the outlet is a flange that is integrally formed with the tool connection tube at an end of the tool connection tube that is exterior to the housing.

Other features and aspects of the invention will become apparent by consideration of the following detailed description and accompanying drawings.

### BRIEF DESCRIPTION OF THE DRAWINGS

FIG. 1 is a perspective view of a power tool assembly including a power tool, a dust extractor, and a secondary handle according to an embodiment of the disclosure.

FIG. 2A is a perspective view of the power tool of FIG. 1.

FIG. 2B is another perspective view of the power tool of FIG. 1.

FIG. 3 is a cross-sectional view of the power tool taken along line 3-3 in FIG. 2A.

FIG. 4A is a front perspective view of a portion of the power tool.

FIG. 4B is a cross-sectional view of the power tool taken along line 4B-4B in FIG. 4A.

FIG. 5 is a perspective view of a portion of the power tool.

FIG. 6 is a perspective view of the dust extractor of FIG. 1.

FIG. 7 is a cross-sectional view of the dust extractor taken along line 7-7 in FIG. 6.

FIG. 8A is a plan view of a portion of the dust extractor in which a suction tube is in an extended position.

FIG. 8B is a plan view of a portion of the dust extractor in which the suction tube is in a retracted position.

FIG. 9 is a cross-sectional view of the dust extractor taken along line 9-9 in FIG. 6.

FIG. 10 is a perspective view of a portion of the dust extractor.

FIG. 11 is a perspective view of a dust box for the dust extractor.

FIG. 12 is a rear perspective view of a portion of the dust box.

FIG. 13 is a front perspective view of a portion of the dust box.

FIG. 14A is a cross-sectional view of the dust extractor coupled to the power tool with a latch mechanism in a first position.

FIG. 14B is a cross-sectional view of the dust extractor coupled to the power tool with the latch mechanism in a second position.

FIG. 15 is a perspective view of the secondary handle of FIG. 1.

FIG. 16 is a cross-sectional view of the power tool assembly with the dust extractor coupled to the power tool.

FIG. 17 is a cross-sectional view of the power tool assembly according to another embodiment of the disclosure.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

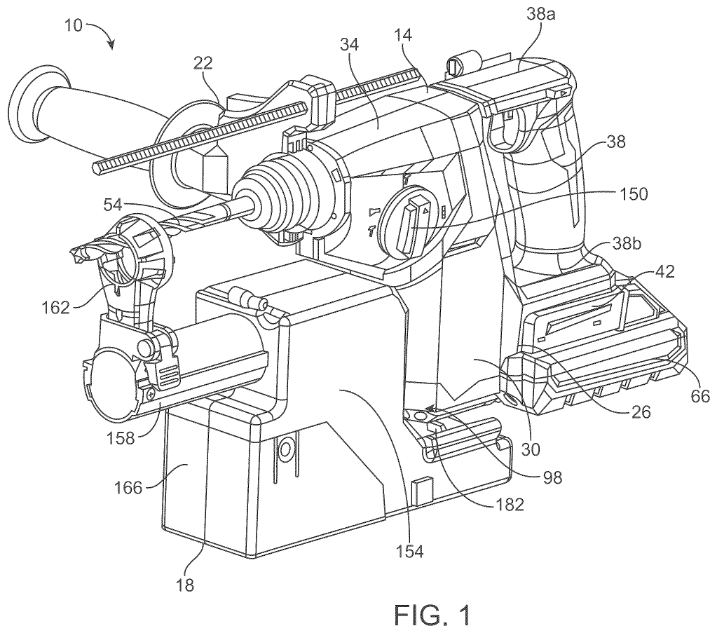

FIG. 1 illustrates a power tool assembly 10 including a power tool 14, a dust extractor 18 that is removably connected, or attached, to the power tool 14, and a secondary handle 22 that is removably connected to the power tool 14. In the illustrated embodiment, the power tool 14 is a drilling machine or rotary power tool, which may be configured as a percussion rotary power tool, a rotary hammer, or a hammer drill. In other embodiments, the power tool 14 may be another type of tool. As will be described in more detail, the dust extractor 18 is operable to collect dust and other debris from a workpiece during a drilling and/or hammering operation performed by the power tool 14. The secondary handle 22 is couplable to the power tool 14 to provide an additional means of holding and controlling the power tool assembly 10.

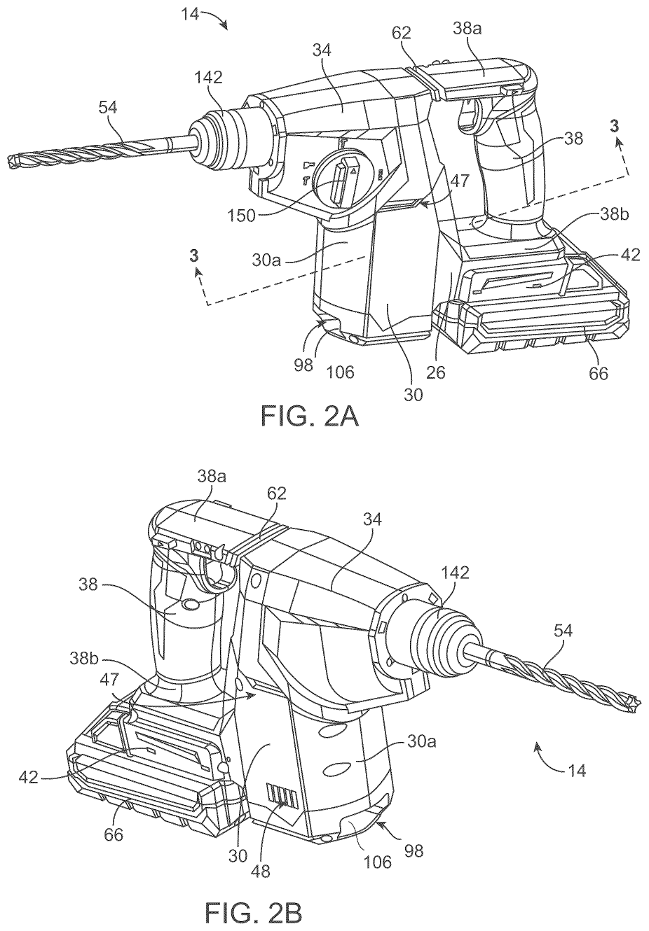

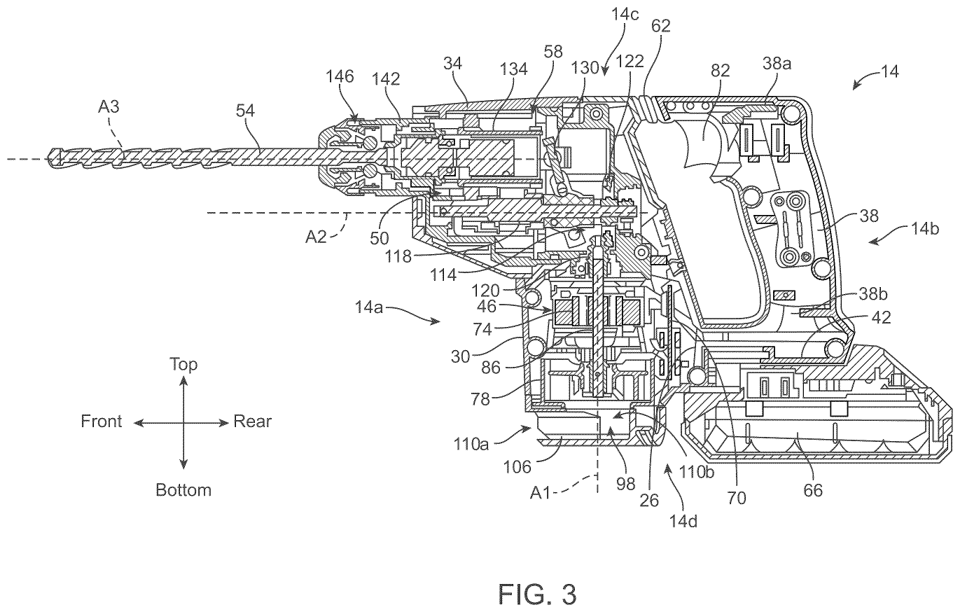

As illustrated in FIGS. 2A-3, the power tool 14 includes a housing 26 having a drive unit housing portion 30, a transmission housing portion 34, a handle housing portion 38, and a battery receptacle portion 42. The drive unit housing portion 30 houses a drive unit 46 that is configured to produce, or generate, torque. The drive unit housing portion 30 defines a vent 48 (FIG. 2B) that allows air to flow into and out of the housing 26. The drive unit housing portion 30 is formed of clamshell halves that may be secured together via fasteners. The transmission housing portion 34 houses a transmission assembly 50, which is configured to receive torque from the drive unit 46 and rotationally drive a tool bit 54, and an impact mechanism 58, which is configured to receive torque from the transmission assembly 50 and apply impacts to the tool bit 54. The handle housing portion 38 is configured to be grasped by a user for control and operation of the power tool 14. In the illustrated embodiment, the handle housing portion 38 is coupled to the transmission housing portion 34 at a first end 38a of the handle housing portion 38 via an elastic member 62 that is configured to absorb and/or dampen vibration between the transmission housing portion 34 and the handle housing portion 38. The battery receptacle portion 42 is positioned at a second end 38b of the handle housing portion 38 opposite from the first end 38a. In the illustrated embodiment, the battery receptacle portion 42 is integrally formed with the drive unit housing portion 30 and the handle housing portion 38. As such, each of the drive unit housing portion 30, the handle housing portion 38, and the battery receptacle portion 42 includes clamshell halves that are coupled together via fasteners. The battery receptacle portion 42 is configured to receive a battery 66 that provides power to the drive unit 46 for producing, or generating, torque. However, it should be understood that the arrangement of the housing portions may vary depending on the embodiment.

With reference to the orientation of the power tool 14 in FIG. 3, the power tool 14 has a front or forward end 14a, a rear or rearward end 14b, a top or upper-most end 14c, and a bottom or bottom-most end 14d. As such, the drive unit housing portion 30 is positioned at a forward and bottom-most section of the power tool 14. The transmission housing portion 34 is positioned above the drive unit housing portion 30 at a forward and upper-most section of the power tool 14. The handle housing portion 38 is positioned behind the transmission housing portion 34 at a rearward and upper-most section of the power tool 14. The battery receptacle portion 42 is positioned below the handle housing portion 38 at a rearward and bottom-most section of the power tool 14. The following disclosure includes reference to directional locations such as forward, rearward, top, and bottom locations. As such, any reference made to directional location is made with respect to the directional signifier indicated in FIG. 3.

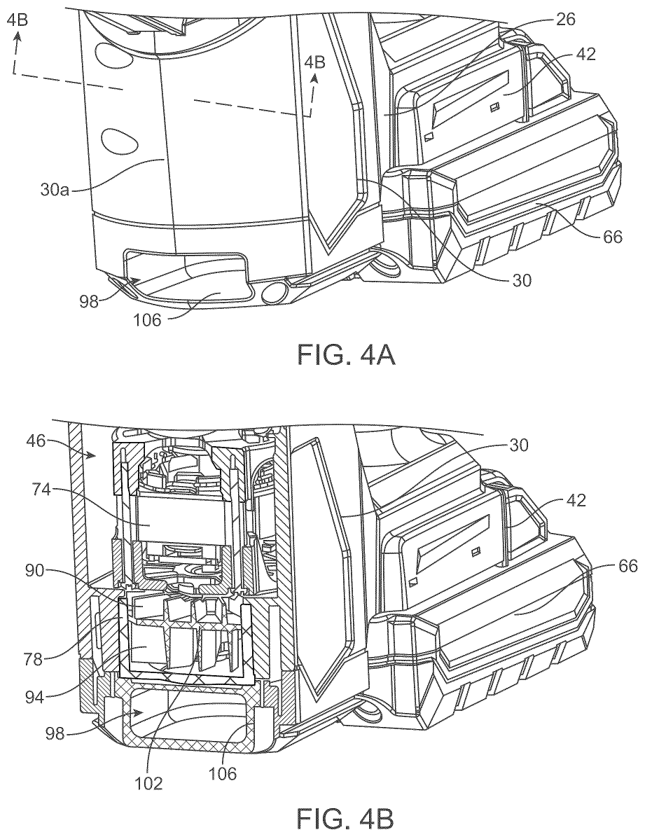

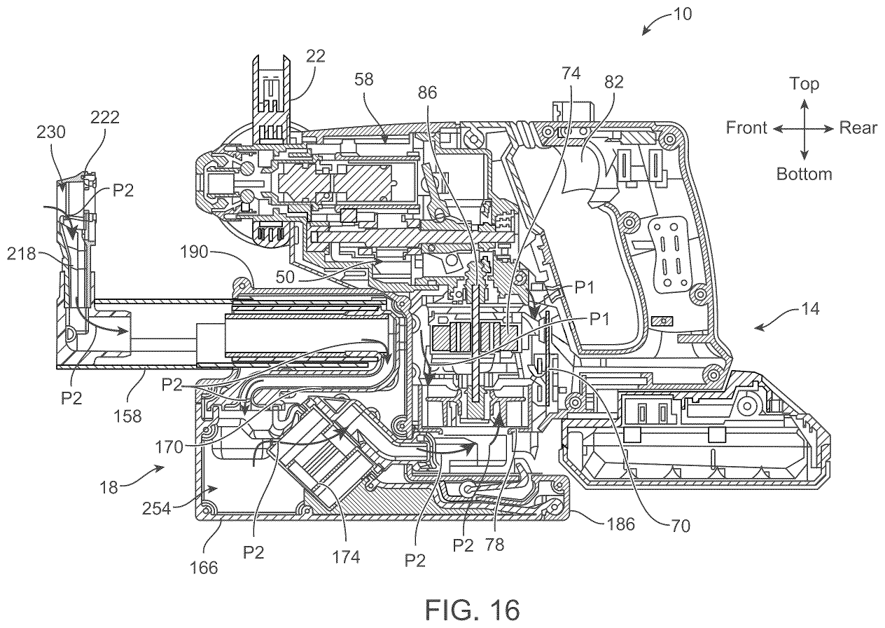

With reference to FIG. 3, the drive unit 46 includes a printed circuit board assembly (“PCBA”) 70, a motor 74, and a fan 78. The PCBA 70 is positioned within the drive unit housing portion 30 adjacent to the battery receptacle portion 42 and is configured to receive power from the battery 66 to control operation of the motor 74. The motor 74 is a brushless direct current (“BLDC”) motor and is configured to rotate under control of the PCBA 70 in response to user input, such as actuation of a trigger 82. The motor 74 includes an output shaft 86 that is rotatable about a drive axis A1. The fan 78 is mounted to the output shaft 86 at a bottom-most end of the output shaft 86. The fan 78 is positioned above a suction inlet 98 defined in the drive unit housing portion 30. As illustrated in FIGS. 4A and 4B, the fan 78 includes a first fan portion 90 and a second fan portion 94. The first fan portion 90 is positioned between the motor 74 and the second fan portion 94. In the illustrated embodiment, the fan 78 includes a dividing wall 102 that substantially separates the first fan portion 90 and the second fan portion 94. With reference to FIGS. 3 and 4B, the first fan portion 90 is configured to generate a first flow of air P1 (FIG. 16) for, among other things, cooling the PCBA 70 and the motor 74. The second fan portion 94 is configured to generate a second flow of air P2 (FIG. 16) for inducing air flow through the dust extractor 18 when the dust extractor 18 (FIG. 1) is coupled to the power tool 14, as will be described in further detail. In the illustrated embodiment, the first flow of air P1 (FIG. 16) and the second flow of air P2 (FIG. 16) may be kept substantially separate from one another by the dividing wall 102 until they are expelled through the vent 48. In other embodiments, the fan 78 may not include a dividing wall 102.

As illustrated in FIGS. 4A and 4B, the drive unit housing portion 30 includes the suction inlet 98 located at the bottom-most part of the housing 26. The suction inlet 98 is defined by a suction conduit 106 having a first opening 110a and a second opening 110b. The suction conduit 106 bends 90-degrees from the first opening 110a, which is located on a front or forward wall 30a of the drive unit housing portion 30, to the second opening 110b, which is located below the fan 78. As such, the second fan portion 94 of the fan 78 is configured to induce the second flow of air P2 (FIG. 16) to enter the suction inlet 98 through the first opening 110a (FIG. 3) along a front-to-rear direction (FIG. 3). The second flow of air P2 then flows through the second opening 110b in a direction extending parallel to the drive axis A1. It should be understood that the shape of the suction conduit 106 may vary in other embodiments and that it may not have a 90-degree turn in other embodiments.

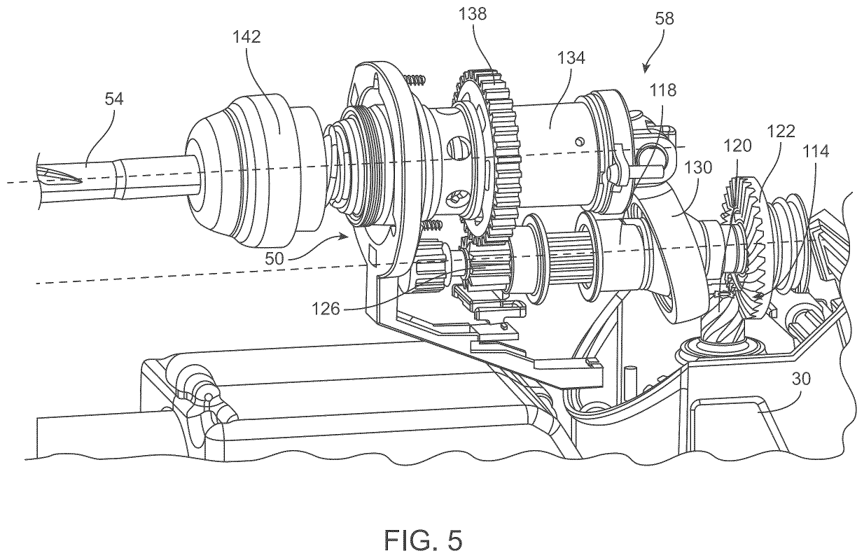

As illustrated in FIGS. 3 and 5, the transmission assembly 50 includes a bevel gear 114 and an intermediate shaft 118 that defines a transmission axis A2 extending in a front-to-rear direction (FIG. 3). The transmission axis A2 is perpendicular to the drive axis A1. Additionally, the transmission axis A2 is spaced apart from the drive axis A1 and is positioned below the drive axis A1. The bevel gear 114 includes a bevel input gear 120 and a bevel output gear 122. The bevel input gear 120 is mounted to the output shaft 86 of the drive unit 46 for rotation with the output shaft 86 about the drive axis A1. The bevel output gear 122 is supported by the transmission housing portion 34 and is oriented perpendicularly to the bevel input gear 120 for converting rotation about the drive axis A1 from the drive unit 46 to rotation about the transmission axis A2. The intermediate shaft 118 is also supported by the transmission housing portion 34 and extends through the bevel output gear 122 such that the intermediate shaft 118 is configured to rotate with the bevel output gear 122. The intermediate shaft 118 includes at least one pinion gear 126 at an end of the intermediate shaft 118 opposite from the bevel output gear 122.

The impact mechanism 58 includes a hammer 130 and an anvil 134 that define an output axis A3 extending in a front-to-rear direction. The output axis A3 is perpendicular to the drive axis A1 and is parallel to the transmission axis A2. The hammer 130 is coupled to the intermediate shaft 118 of the transmission assembly 50 such that rotation of the intermediate shaft 118 effects the hammer 130 to strike the anvil 134 at periodic intervals. Specifically, the hammer 130 strikes the anvil 134 in a direction extending along the output axis A3. The anvil 134 includes an anvil gear 138 that is meshed with the pinion gear 126 of the intermediate shaft 118 such that the intermediate shaft 118 is configured to drive rotation of the anvil 134 via the engagement between the pinion gear 126 on the intermediate shaft 118 and the anvil gear 138 on the anvil 134.

With continued reference to FIGS. 3 and 5, the power tool 14 further includes an output chuck 142 that extends through the transmission housing portion 34 at the front end 14a of the power tool 14. The output chuck 142 is configured to receive the tool bit 54. In the illustrated embodiment, the output chuck 142 includes a ball detent mechanism 146 for retaining the tool bit 54. When the tool bit 54 is received by the output chuck 142, the tool bit 54 extends along and is configured to rotate about the output axis A3. As such, the output axis A3 may also be referred to as an output axis A3. In other embodiments, the output chuck 142 may include different features for retaining the tool bit 54. The output chuck 142 is engaged with the anvil 134 such that rotation from the transmission assembly 50 and hammer strikes from the impact mechanism 58 is transferred to the tool bit 54 from the anvil 134 when the tool bit 54 is coupled to the output chuck 142. As such, the drive unit 46 is configured to rotationally drive the tool bit 54 through the transmission assembly 50 and the anvil 134 for performing a drilling operation, and is configured to produce axial impacts on the tool bit 54 through the transmission assembly 50 and the impact mechanism 58 for performing a hammering operation. With reference to FIGS. 2A and 5, the power tool 14 includes a mode selection knob 150 that is engaged with the transmission assembly 50 and the impact mechanism 58 for placing the power tool 14 in a hammer-only mode, a drilling-only mode, or a hammer and drilling mode.

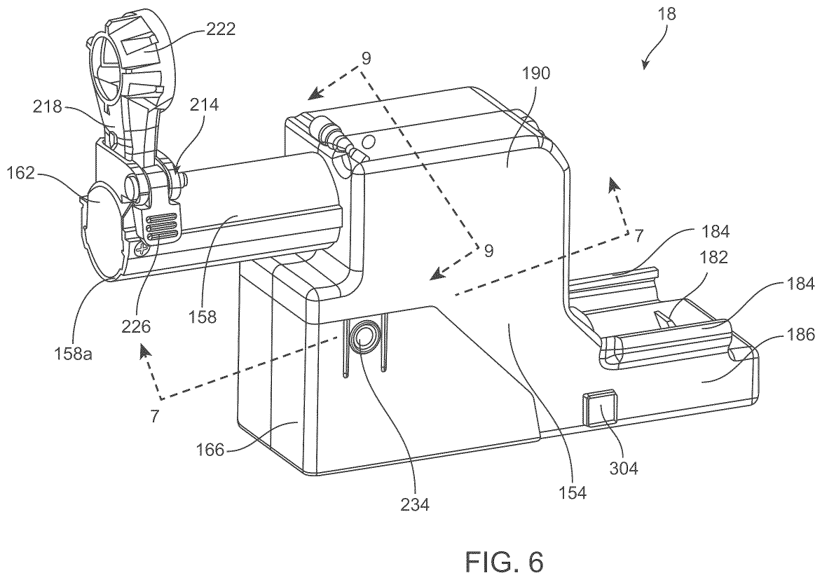

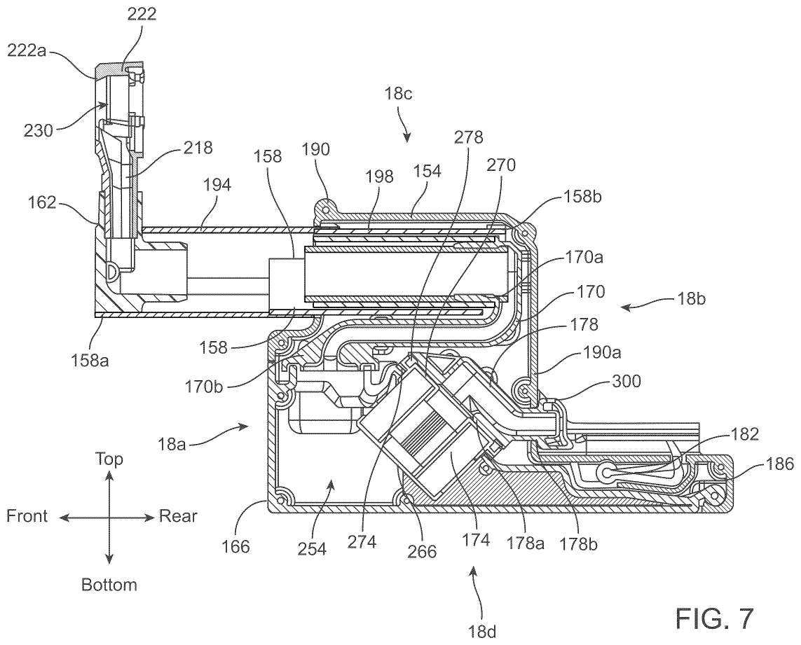

FIGS. 6 and 7 illustrate the dust extractor 18. The dust extractor 18 includes a dust extractor housing 154, a suction tube 158, a suction head 162, a dust box 166, a dust box connection tube 170, filter 174, a tool connection tube 178, and a latch mechanism 182. As will be described in more detail, the dust extractor 18 is removably couplable with the power tool 14 (FIG. 1) at the bottom of drive unit housing portion 30 (FIG. 2A). The dust extractor 18 does not include a separate motor 74 and fan 78 for generating a suctioning flow of air. Rather, when the dust extractor 18 is coupled to the power tool 14, the dust extractor 18 may be aligned with the suction inlet 98 such that the motor 74 and the fan 78 onboard the power tool 14 induces the second flow of air P2 (FIG. 16) through the dust extractor 18 for suctioning dust and debris generated during the drilling and/or the hammering operation of the power tool 14.

As similarly described with respect to the orientation of the power tool 14 in FIG. 3, and with reference to FIG. 7, the dust extractor 18 has a front or forward end 18a, a rear or rearward end 18b, a top or upper-most end 18c, and a bottom or bottom-most end 18d. When the dust extractor 18, as oriented in FIG. 7, is coupled to the power tool 14, as oriented in FIG. 3, the directional signifier for the power tool 14 and the dust extractor 18 are aligned. Returning reference to FIGS. 6 and 7, the dust extractor housing 154 includes a rear housing portion 186 and a front housing portion 190. When the dust extractor 18 is coupled to the power tool 14 (FIG. 2A), the rear housing portion 186 of the dust extractor housing 154 extends below the drive unit housing portion 30 of the power tool 14 (FIG. 2A). The front housing portion 190 of the dust extractor housing 154 extends upward and forward from the rear housing portion 186 of the dust extractor 18 such that when the dust extractor 18 is coupled to the power tool 14 (FIG. 2A), a rear wall 190a of the front housing portion 190 of the dust extractor housing 154 may abut the front wall 30a of the drive unit housing portion 30 of the power tool 14 (FIG. 2A). The dust extractor housing 154 includes clamshell halves that may be coupled together via fasteners.

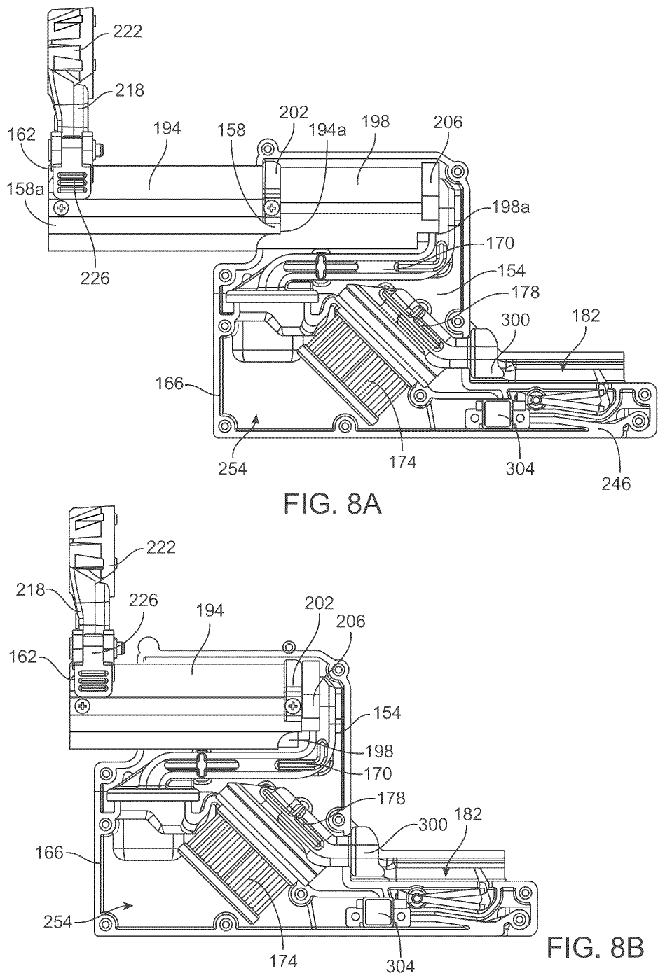

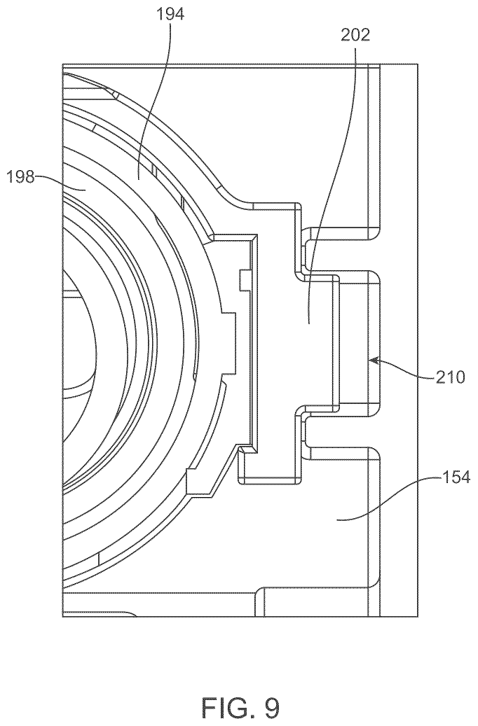

With reference to FIGS. 8A and 8B, the suction tube 158 includes a first portion 194 and a second portion 198. The suction tube 158 is a telescoping tube such that the first portion 194 is slidable relative to the second portion 198. Specifically, the suction tube 158 is adjustable along an extension direction along a longitudinal axis between an extended position (FIG. 8A), in which the suction head 162 is positioned furthest from the power tool 14, and a retracted position (FIG. 8B), in which the suction head 162 is positioned closest to the power tool 14. The extension direction extends parallel to the transmission axis A2 and the output axis A3. The first portion 194 of the suction tube 158 includes a first stop 202, and the second portion 198 of the suction tube 158 includes a second stop 206. The first stop 202 is positioned at a rearward end 194a of the first portion 194 of the suction tube 158, and the second stop 206 is positioned at a rearward end 198a of the second portion 198 of the suction tube 158. With reference to FIG. 9, the first stop 202 is configured to slide along a rail 210 defined by the dust extractor housing 154 as the first portion 194 slides relative to the second portion 198. In the extended position, the first stop 202 is positioned at a forward-most position along the rail 210 such that the dust extractor housing 154 inhibits the first portion 194 from sliding further in the forward direction. Returning reference to FIGS. 8A and 8B, in the retracted position, the first stop 202 engages the second stop 206 such that the second stop 206 inhibits the first portion 194 from sliding further in the rearward direction.

As illustrated in FIG. 1, the suction head 162 is positioned at a forward end 158a of the suction tube 158. When the dust extractor 18 is coupled to the power tool 14, the tool bit 54 may extend through the suction head 162 (e.g., as illustrated in FIG. 1). The suction head 162 includes a clamping mechanism 214, a head tube 218, and a collecting shroud 222. The clamping mechanism 214 includes a latch 226 that is rotatable to selectively secure the suction head 162 at the forward end 158a of the suction tube 158. The head tube 218 extends from the clamping mechanism 214 to the collecting shroud 222 and provides a conduit for air to flow between the suction tube 158 and the collecting shroud 222. The collecting shroud 222 is substantially frustoconical and includes an opening 230 that enables the tool bit 54 to extend through the suction head 162. During a working operation, a front end 222a of the collecting shroud 222 may be pressed against a work surface such that the tool bit 54 (FIG. 1) extends through the collecting shroud 222 and into the work surface to contain dust and debris generated during the drilling and/or hammering operation within the collecting shroud 222.

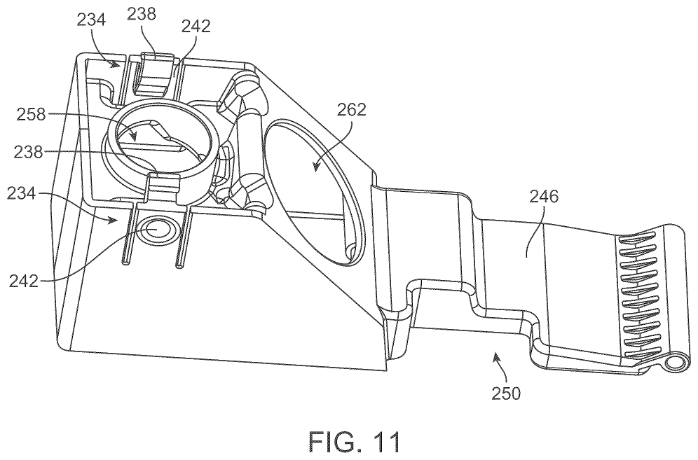

With reference to FIGS. 7 and 11, the dust box 166 is pivotably connected to the dust extractor housing 154. Specifically, the dust box 166 includes a tongue portion 246 with a hinge portion 248 that allows for rotation of the dust box 166 relative to the dust extractor housing 154. The dust box 166 is pivotable between an open position and a closed position. When in the open position, the dust box 166 is released from the dust extractor housing 154. When in the closed position, the dust box 166 is coupled to the dust extractor housing 154. It should be understood that the hinge portion 248 of the dust box 166 remains connected to the dust extractor housing 154 in both the open and the closed positions. Only the main portion of the dust box 166 is released and coupled to the dust extractor housing 164 then the dust box 166 is pivoted between the closed position and the open position, respectively.

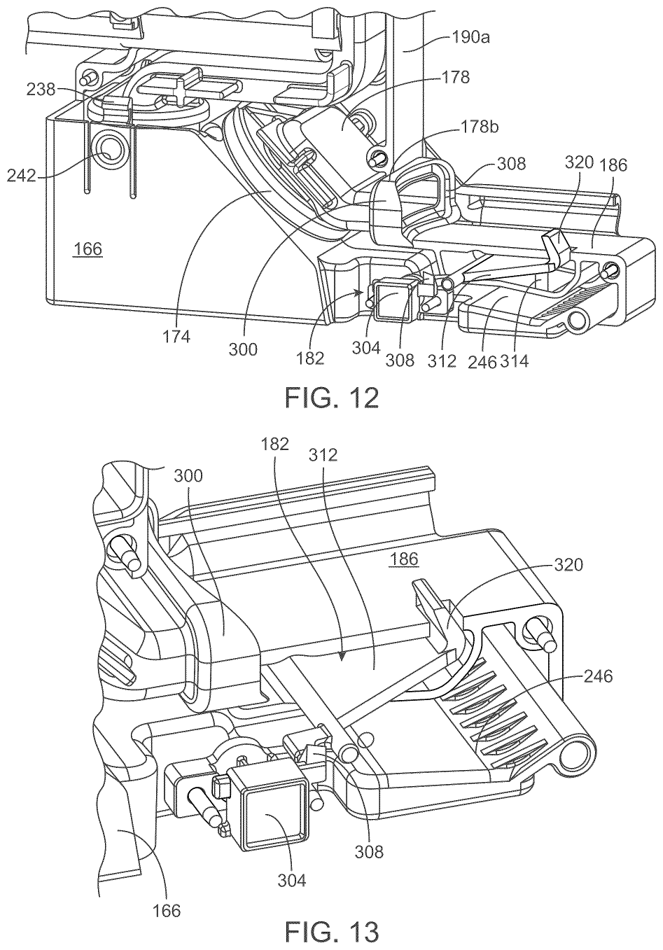

As illustrated in FIG. 11, the dust box 166 includes coupling mechanisms 234 that engage the dust extractor housing 154 to couple the dust box 166 to the dust extractor housing 154 when in the closed position. Each of the coupling mechanisms 234 includes a hook 238 that is formed on a tab 242. The hook 238 is configured to engage the dust extractor housing 154, and the tab 242 is formed on the outer surface of the dust box 166. The tab 242 is biasable, or pressable, to move the hook 238 out of engagement with the dust extractor housing 154 for removing the dust box 166 from the dust extractor housing 154. The dust box 166 further includes a tongue portion 246 that is insertable into the rear housing portion 186 of the dust extractor housing 154 to couple the dust box 166 to the dust extractor housing 154. Specifically, the tongue portion 246 creates an interference fit with the dust extractor housing 154 for inhibiting the dust box 166 from being removed from the dust extractor housing 154 without actuation of the coupling mechanisms 234. The tongue portion 246 includes a recess 250 that provides space for accommodating the latch mechanism 182 (FIG. 12) when the dust box 166 is coupled to the dust extractor housing 154.

With continued reference to FIGS. 7 and 11, the dust box 166 defines a dust storing space 254, a dust box inlet 258, and a dust box outlet 262. The dust storing space 254 is configured to store dust that has been generated during the drilling and/or hammering operation and suctioned into the dust extractor 18 via the second flow of air P2 (FIG. 16) induced by the fan 78 onboard the power tool 14 (FIG. 3). The dust box inlet 258 provides an opening for a flow of air to enter the dust storing space 254, and the dust box outlet 262 provides an opening for the flow of air to exit the dust storing space 254. The dust box inlet 258 is oriented such that air flow is configured to flow through the dust box inlet 258 in a direction that extends parallel to the output axis A1 of the power tool 14 (FIG. 3). Stated another way, the flow of air is configured to flow through the dust box inlet 258 in a top-to-bottom direction. The dust box outlet 262 is oriented such that air flow is configured to flow through the dust box outlet 262 at an oblique angle with the output axis A3 of the power tool 14 (FIG. 3). Specifically, the dust box outlet 262 is oriented at a 45-degree angle with the output axis A3. Stated another way, the dust box outlet 262 is oriented at a 45-degree angle relative to the dust box inlet 258. In other embodiments, the dust box outlet 262 may be oriented at any angle between 0 and 90-degrees relative to the dust box inlet 258.

As illustrated in FIG. 7, the dust box connection tube 170 is positioned within the dust extractor housing 154 between the suction tube 158 and the dust box 166 when the dust box 166 is coupled to the dust extractor housing 154. The dust box connection tube 170 has a first end 170a that is connected to a rearward end 158b of the suction tube 158 and a second end 170b that is connectable to the dust box inlet 258 when the dust box 166 is connected to the dust extractor housing 154. The dust box connection tube 170 snakes back and forth between the suction tube and the filter. Specifically, the dust box connection tube 170 extends downward from the suction tube 158, bends in a 90-degree manner, extends toward a forward end 18a of the dust extractor 18, and finally connects to the dust box inlet 258 by another 90-degree turn connection. In other words, the dust box connection tube 170 extend generally parallel to the suction tube 158 with the dust box connection tube 170 overlapping with at least a portion of the suction tube 158. As such, the dust box connection tube 170 provides a conduit for air to flow from the suction tube 158 to the dust storing space 254 of the dust box 166.

As illustrated in FIGS. 7 and 11, the filter 174 is at least partially positioned in the dust storing space 254 of the dust box 166 and extends through the dust box outlet 262. In some embodiments, the filter 174 is oriented at an angle in order to save space within the dust box 166 and make the dust extractor more compact. By orienting the filter 174 at an angle, the height (i.e., the vertical distance as shown in FIG. 7) of the dust box 166 may be reduced. For example, the filter 174 may extend at, or be oriented in, an oblique angle relative to the drive axis A1 of the power tool 14 (FIG. 3). The filter 174 may also extend at, or be oriented in, an oblique angle relative to both the transmission axis A2 and the output axis A3 (FIG. 3). Specifically, the filter 174 is oriented at a 45-degree angle relative to each of the drive axis A1, the transmission axis A2, and the output axis A3. The filter 174 may extend at a 45-degree relative to the dust box inlet 258. By providing the filter 174 at a 45-degree angle relative to the drive axis A1, the transmission axis A2, and the output axis A3, the dust extractor 18 is allowed to be more compact than conventional dust extractors. In other embodiments, the filter 174 may extend at any angle between 0 and 90-degrees relative to the drive axis A1, the transmission axis A2, and the output axis A3. For example, the filter 174 may extend at, or be oriented in, a first angle relative to the drive axis A1 and a second angle relative to the transmission axis A2 and the output axis A3, and the first angle and the second angle may add up to 90 degrees. The filter 174 includes a body 266, a cap 270, a first seal 274, and a second seal 278. In the illustrated embodiment, the body 266 and the cap 270 are formed integrally together. In other embodiments, the body 266 and the cap 270 are formed separately and may be coupled together. The first seal 274 is positioned on an underside of the cap 270 and faces the dust box outlet 262. The second seal 278 is positioned on a topside of the cap 270 and faces the tool connection tube 178 when the dust box 166 is coupled to the dust extractor housing 154. In the illustrated embodiment, the first seal 274 and the second seal 278 are o-rings. In other embodiments, the first seal 274 and the second seal 278 may be another type of sealing member and/or may be different sealing members relative to one another.

With reference to FIG. 7, the tool connection tube 178 is positioned within the dust extractor housing 154 beneath the suction tube 158 and extends through the rear wall 190a of the front housing portion 190 of the dust extractor housing 154. Specifically, a first end 178a of the tool connection tube 178 is connected to the filter 174, and a second end 178b of the tool connection tube 178 is positioned external of the dust extractor housing 154. When the dust box 166 is connected to the dust extractor housing 154 with the filter 174 positioned in the dust box outlet 262, the first end 178a of the tool connection tube 178 is configured to compress the first seal 274 between the cap 270 and the dust box outlet 262 and is configured to compress the second seal 278 with the cap 270. As such, an air-tight seal is created that inhibits air from escaping from the filter 174. With reference to FIGS. 7 and 12, the tool connection tube 178 includes a flange 300 at the second end 178b of the tool connection tube 178. The flange 300 may also be referred to as an outlet of the dust extractor 18. In the illustrated embodiment, the flange 300 is positioned exterior to the dust extractor housing 154. The flange 300 is shaped to interface with the suction conduit 106 of the power tool 14 (FIG. 3). Although not illustrated, the flange 300 may include a sealing member, such as an o-ring or a foam insert. As such, when the flange 300 interfaces with the suction conduit 106 (FIG. 4A), the sealing member may be compressed between the flange 300 and the suction conduit 106 (FIG. 4A) to create an air-tight seal between the dust extractor 18 and the power tool 14.

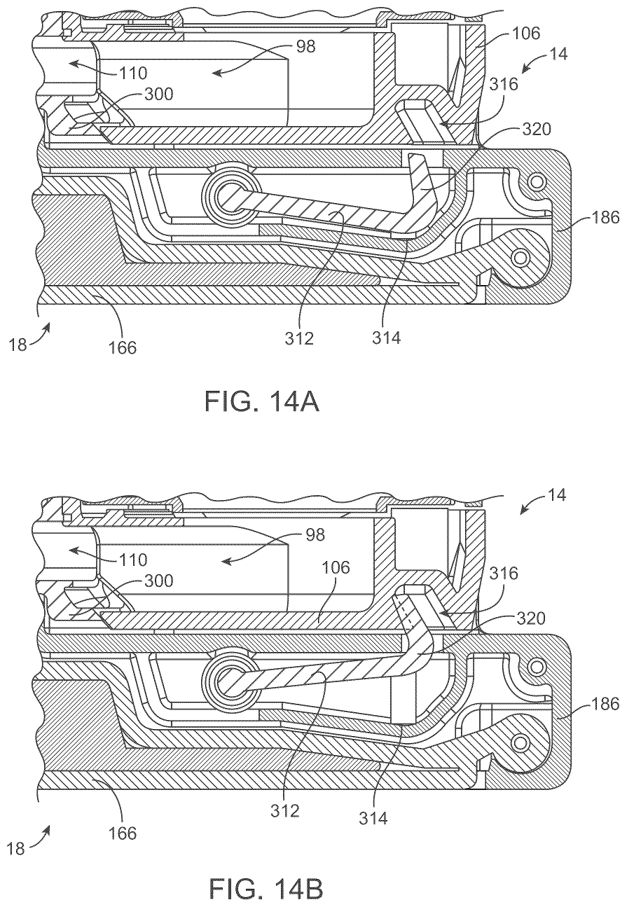

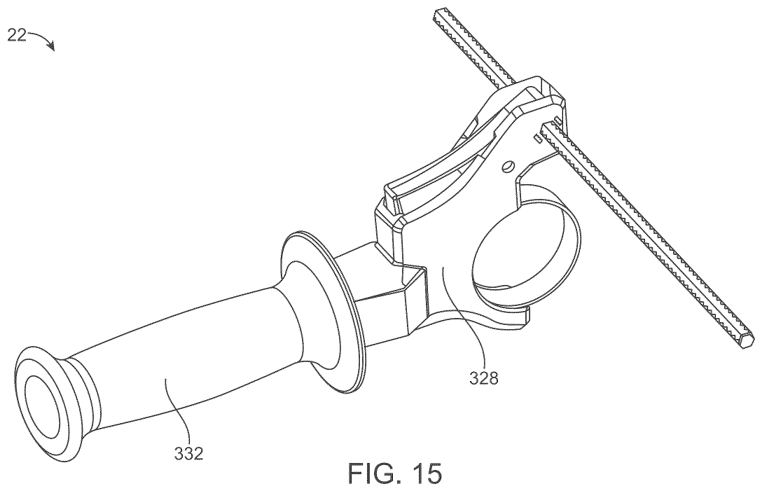

As illustrated in FIGS. 12 and 13, the latch mechanism 182 is housed within the rear housing portion 186 of the dust extractor 18 and enables the dust extractor 18 to releasably connect to the power tool 14 (FIG. 1). The latch mechanism 182 includes a button 304, one or more camming surface 308, a pivotable locking hook or locking member 312, and a spring 314. With reference to FIGS. 13-14B, the locking member 312 selectively engageable with a slot 316 in the suction conduit 106 of the power tool 14 to releasably connect the dust extractor 18 and the power tool 14. The locking member 312 may also be referred to as a latch. When a user presses the button 304, the camming surfaces 308 work together to rotate the locking member 312 between a locked and an unlocked position. The spring 314 biases the locking member 312 into the locked position. When the dust extractor 18 is slid towards the power tool 14 for coupling the dust extractor 18 and the power tool 14 together, a curved surface 320 of the locking member 312 cams against the suction conduit 106 of the power tool 14 to rotate the locking member 312 towards the unlocked position. In other words, the suction conduit 106 pushes the locking member 312 against the bias of the spring 314 to move the locking member 312 into the unlocked position. When the locking member 312 reaches the slot 316, the bias of the spring 314 is free (e.g., uninhibited by the suction conduit 106) to rotate the locking member 312 towards the locked position such that the locking member 312 moves into the slot 316. With the locking member 312 positioned within the slot 316, an interference is created between the dust extractor 18 and the power tool 14 that inhibits the dust extractor from being removed from the power tool 14. In order to disconnect the dust extractor 18 from the power tool 14, a user may press the button 304 to cause the camming surfaces 308 to rotate the locking member 312 against the bias of the spring 314 and towards the unlocked position. This moves the locking member 312 out of the slot 316 and removes the interference between the dust extractor 18 and the power tool 14 to allow the dust extractor 18 to be disconnected from the power tool 14.

Returning reference to FIGS. 6 and 7, the arrangement of the components of the dust extractor 18 improves the overall compactness of the power tool assembly 10 (FIG. 1). For example, the dust box connection tube 170 effectively winds, or snakes, from a rear end 18b of the dust extractor 18 to a front end 18a of the dust extractor 18 to utilize the space within the dust extractor housing 154 more efficiently. In another example, the filter 174 is oriented at 45-degrees relative to the dust box inlet 258 (FIG. 7), and therefore, requires less space within the dust extractor 18, thereby allowing the dust extractor 18 to be reduced in size. By improving the compactness of the dust extractor 18, and resultantly, the power tool assembly 10 (FIG. 1), the power tool assembly 10 (FIG. 1) may, among other advantages, be fit more easily into small working spaces, and may be more easily stored.

FIG. 15 illustrates the secondary handle 22. The secondary handle 22 includes a clamp portion 328 and a grip portion 332. The clamp portion 328 is configured to engage an outer surface of the output chuck 142 (FIG. 5) to couple the secondary handle 22 to the power tool 14 (FIG. 2A). The grip portion 332 extends from the clamp portion 328 and is configured to be gripped by a user to improve control of the power tool 14. The clamp portion 328 may be adjustable such that the grip portion 332 is movable to different orientations relative to the power tool 14 (FIG. 2A).

With reference to FIGS. 1 and 16, to operate the power tool assembly 10, the power tool 14, the dust extractor 18, and the secondary handle 22 may all be coupled together. In some embodiments, the power tool 14 may be operable without the dust extractor 18 and the secondary handle 22. Specifically, with reference to FIGS. 13-14B, a top surface of the rear housing portion 186 of the dust extractor 18 may be slid along the suction conduit 106 in a front-to-rear direction until the latch mechanism 182 reaches the slot 316 in the suction conduit 106. Until the latch mechanism 182 reaches the slot 316, a bottom surface of the suction conduit 106 pushes the locking member 312 against the bias of the spring 314. Once the latch mechanism 182 reaches the slot 316, the locking member 312 may cam against the suction conduit 106 and into the slot 316 such that the suction conduit 106 inhibits the locking member 312 from being removed from the slot 316, and thereby inhibits the dust extractor 18 from being removed from the power tool 14. With reference to FIG. 6, the rear housing portion 186 of the dust extractor 18 may include rails 184 that assist with the relative sliding between the suction conduit 106 and the dust extractor 18.

Returning to reference to FIGS. 1 and 16, with the dust extractor 18 coupled to the power tool 14, the trigger 82 may be actuated to provide user input to the PCBA 70 for driving rotation of the motor 74. As the motor 74 drives rotation of the output shaft 86, the transmission assembly 50 is configured to drive rotation of the tool bit 54, as described above, and the impact mechanism 58 is configured to apply impacts on the tool bit 54. Additionally, the motor 74 drives rotation of the fan 78 through the output shaft 86. With reference to FIGS. 4B and 16, the first fan portion 90 induces the first flow of air P1, and the second fan portion 94 induces the second flow of air P2. The first flow of air P1 and the second flow of air P2 are pulled toward the fan 78 from opposite directions and then expelled together through the vent 48. For example, in the illustrated embodiment, the first flow of air P1 travels along an airflow path parallel to the rotational axis of the fan (which is along the drive axis A3 in this arrangement) in a first direction (e.g., downward). The second flow of air P2 travels along an airflow path parallel to the rotational axis of the fan (i.e., along drive axis A3) in a second direction (e.g., upward).

The first fan portion 90 draws in air through air inlets 47 (FIG. 2A) and induces the air to flow downward toward the motor 74 for cooling the motor 74. In some embodiments, an inner surface of the drive unit housing 30 may optionally include a rib to guide the cooling first flow of air P1 into the motor 74. The first fan portion 90 may further draw cooling air across the PCBA 70 to cool the PCBA 70. Once the first flow of air P1 reaches the first fan portion 90, the fan 78 blows the air out of the vents 48 (FIG. 2B). The second fan portion 94 induces the second flow of air P2 to suction dust and debris into the dust extractor 18 along a flow path. Specifically, the second fan portion 94 draws in a mixture of debris and air (i.e., a dirty air mixture) through the opening 230 in the collecting shroud 222 (i.e., a first end of the flow path), down the head tube 218, into and along the suction tube 158, through the dust box connection tube 170, and into the dust box 166 through the dust box inlet 258 (FIG. 11). Once the dirty air mixture is in the dust box 166, the dirty air mixture is drawn through the filter 174 and out of the dust box 166 through the dust box outlet 262 (FIG. 11). As the dirty air mixture is drawn through the filter 174, the filter 174 separates the dust and debris from the air such that the dust and debris remain in the dust storing space 254, and the air flows through the filter 174 to the tool connection tube 178. The clean air then enters the power tool 14 in a front-to-rear direction by traveling from the tool connection tube 178 and into the suction inlet 98. Specifically, the clean air may flow through an opening in the flange 300 (i.e., a second end of the flow path) and into the suction inlet 98. The fan 78 then blows, or exhausts, the clean air from the power tool 14 through the vent 48 (FIG. 2B).

Once the working operation (e.g., drilling and/or hammering) is complete, the dust extractor 18 may be removed from the power tool 14 for, among other reasons, cleaning the dust extractor 18 and disposing of dust and debris from the dust box 166. As such, with reference to FIGS. 13-14B, the button 304 of the latch mechanism 182 may be pressed for removal of the dust extractor 18. Pressing the button 304 engages the camming surface 308 with the locking member 312 to move the locking member 312 against the bias of the spring 314 and out of the slot 316 in the suction conduit 106. Once the locking member 312 is removed from the slot 316, the dust extractor 18 is free to be removed from the power tool 14. With the dust extractor 18 removed from the power tool 14, the dust box 166 may be removed from the dust extractor 18 through actuation of the coupling mechanisms 234. Dust and debris may then be emptied from the dust storage space 254. Alternatively, a user may remove the dust box 166 from the dust extractor 18 without removing the dust extractor from the power tool 14 to remove dust and debris from the dust storage space 254.

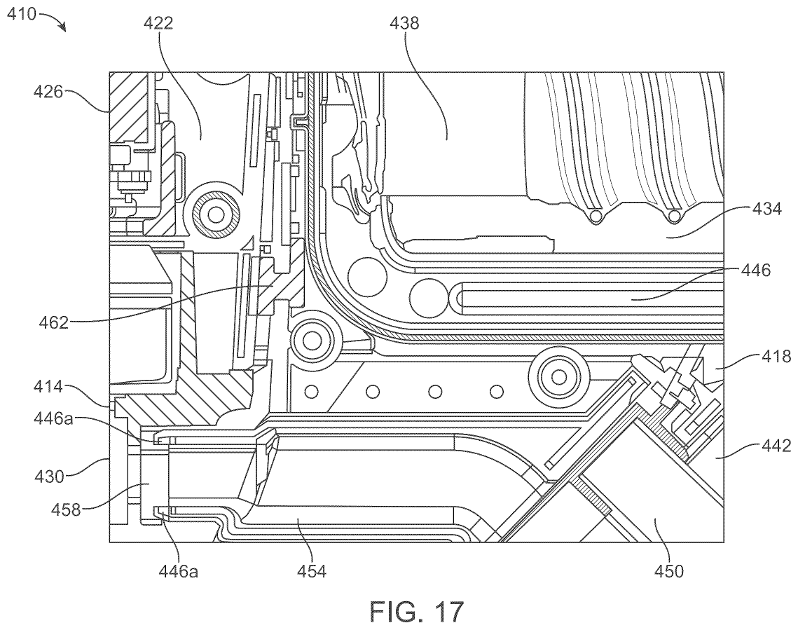

FIG. 17 illustrates a portion of a power tool assembly 410 according to another embodiment of the disclosure. The power tool assembly 410 at least includes a power tool 414 and a dust extractor 418 that is removably connected to the power tool 414. The portion of the power tool assembly 410 illustrated in FIG. 17 is a cross-section of the power tool 414 and the dust extractor 418 at a point of connection between the power tool 414 and the dust extractor 418. The power tool 414 may be substantially similar to the power tool 14 of FIGS. 2A-3, and the dust extractor 418 may be substantially similar to the dust extractor 18 of FIGS. 6 and 7, except for the differences described herein.

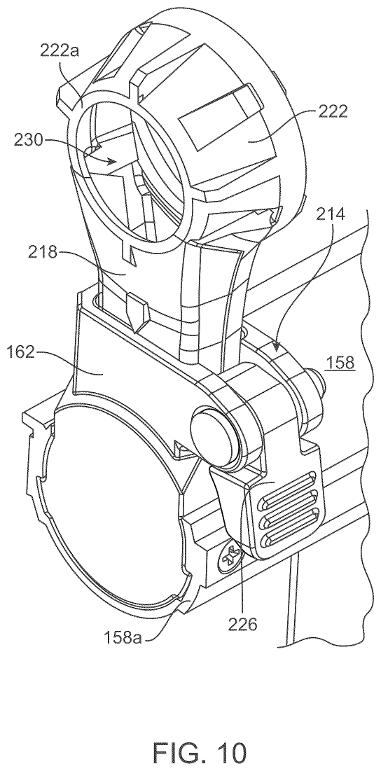

As illustrated in FIG. 17, the power tool 414 includes, among other things, a housing 422, a motor 426, and a suction conduit 430. Although not illustrated in FIG. 17, the power tool 414 may additionally include, among other things, a fan, such as the fan 78 of FIG. 4B, that is configured to be driven by the motor 426 to induce a suctioning flow of air through the suction conduit 430. The dust extractor 418 includes, among other things, a dust extractor housing 434, a suction tube 438, a dust box 442, a dust box connection tube 446, a filter 450, and a tool connection tube 454. Although not illustrated in FIG. 17, the dust extractor 418 may additionally include, among other things, a suction head, such as the suction head 162 of FIG. 7. Accordingly, the power tool assembly 410 of FIG. 17 may function substantially similarly to the power tool assembly 10 of FIG. 1-16 in that the motor 426 of the power tool 414 may induce a flow of suctioning air at the suction head for suctioning dust and debris generated during a working operation of the power tool 414.

With continued reference to FIG. 17, the power tool 414 further includes a seal 458, and the dust extractor 418 additionally includes a damper 462. The seal 458 is provided at an opening of the suction conduit 430. In the illustrated embodiment, the seal 458 is a foam seal that may also function as an insulator that inhibits suctioning airflow from leaking from the tool connection tube 446 at a point of connection between the tool connection tube 446 and the suction conduit 430. Specifically, the tool connection tube 446 may include elbows 446a that are configured to engage and compress the seal 458 at the opening of the suction conduit 430 when the dust extractor 418 is coupled to the power tool 414. The damper 462 is provided in the dust extractor housing 434 of the dust extractor 418 and may protrude from the dust extractor housing 434 to engage the housing 422 of the power tool 414. In the illustrated embodiment, the damper 462 is a rubber grommet. The engagement between the rubber grommet, which is secured to the dust extractor housing 434, and the housing 422 of the power tool 414 inhibits the power tool 414 and the dust extractor 418 from shaking relative to one another during operation of the power tool assembly 410. As such, the inclusion of the damper 462 may improve user experience during operation of the power tool assembly 410. While the seal 458 and the damper 462 are described with respect to the power tool assembly 410 of FIG. 17, the seal 458 and the damper 462 may be implemented, or included, in the power tool assembly 10 of FIGS. 1-16.

Although the disclosure has been described in detail with reference to certain preferred embodiments, variations and modifications exist within the scope and spirit of one or more independent aspects of the disclosure as described. Various features of the present disclosure are set forth in the following claims.

1. A power tool assembly comprising:
a power tool including
an output chuck configured to receive a tool bit for performing a working operation, the output chuck defining an output axis,
a housing defining a suction inlet,
a motor disposed within the housing and defining a drive axis, and
a fan rotationally driven by the motor, the fan configured to induce a flow of suctioning air through the suction inlet; and
a dust extractor removably coupled to the power tool, the dust extractor including a tool connection tube that interfaces with the suction inlet when the dust extractor is connected to the power tool,
wherein the flow of suctioning air induced by the fan flows from the dust extractor to the power tool in a direction extending parallel to the output axis.

2. The power tool assembly of claim 1, wherein the output axis and the drive axis are perpendicular.

3. The power tool assembly of claim 1, wherein the dust extractor includes a filter, and wherein the filter is disposed at an oblique angle relative to the output axis and the drive axis.

4. The power tool assembly of claim 1, wherein the power tool further includes a transmission assembly having an intermediate shaft extending along a transmission axis, and wherein the transmission axis extends parallel to the output axis and is positioned below the output axis.

5. The power tool assembly of claim 1, wherein one of the power tool and the dust extractor includes a latch mechanism having a pivotable latch, and the other of the power tool and the dust extractor includes a slot for receiving the latch to couple the power tool and the dust extractor together.

6. The power tool assembly of claim 5, wherein the latch mechanism further includes a spring and a button, the spring biasing the latch into a locked position, the button pressable to adjust the latch to an unlocked position.

7. The power tool assembly of claim 1, wherein the fan includes a first fan portion that is configured to induce a flow of cooling air to enter the housing at an air inlet formed in the housing and configured to blow the flow of cooling air out of the housing through a vent formed in the housing, and wherein the flow of cooling air travels from the air inlet to the vent in a first direction along the drive axis.

8. The power tool assembly of claim 7, wherein the fan includes a second fan portion that is configured to induce a flow of suctioning air to enter the housing through the suction inlet and configured to blow the flow of suctioning air out of the vent, wherein the flow of suctioning air travels from the suction inlet to the vent in a second direction along the drive axis, and wherein the first direction and the second direction are opposite directions.

9. A power tool assembly comprising:
a power tool including
an output chuck configured to receive a tool bit for performing a working operation, the output chuck defining an output axis,
a tool housing including a suction conduit that defines a suction inlet,
a motor disposed within the housing and having an output shaft defining a drive axis, and
a fan rotationally driven by the motor, the fan configured to induce a flow of suctioning air through the suction inlet; and
a dust extractor removably coupled to the power tool and including an outlet that is configured to engage the suction inlet such that the fan of the power tool induces the flow of suctioning air through the dust extractor, the dust extractor further including
a dust extractor housing having a front end and rear end,
a tool connection tube defining the outlet of the dust extractor and configured to engage with the suction inlet of the power tool, a portion of the tool connection tube extending parallel to the output axis and protruding from a wall of the dust extractor housing,
wherein the dust extractor is configured to be attached to the tool housing of the power tool by sliding the dust extractor in a front-to-rear direction until the tool connection tube engages with the suction inlet.

10. The power tool assembly of claim 9, wherein the suction inlet includes an insulator, and wherein the outlet engages the insulator when the dust extractor is coupled to the power tool such that the insulator inhibits suctioning air from leaking from the power tool assembly at a point of connection between the power tool and the dust extractor.

11. The power tool assembly of claim 9, wherein one of the power tool and the dust extractor includes a latch mechanism having a pivotable latch and a spring that biases the pivotable latch into a locked position, and the other of the power tool and the dust extractor includes a slot for receiving the latch to couple the power tool and the dust extractor together.

12. The power tool assembly of claim 11, wherein attachment of the dust extractor to the power tool includes sliding a top surface of the rear housing portion of the dust extractor along a bottom surface of the suction conduit in a front-to-rear direction such that the bottom surface of the suction conduit moves the pivotable latch against a bias of the spring, and wherein the spring biases the pivotable latch into the slot after the pivotable latch reaches the slot during the sliding.

13. The power tool assembly of claim 9, wherein the dust extractor further includes a rubber grommet that protrudes from the dust extractor housing to engage the tool housing of the power tool when the power tool and the dust extractor are coupled together, the rubber grommet configured to inhibit relative shaking between the power tool and the dust extractor.

14. A dust extractor configured to be removably attached to a power tool, the dust extractor comprising:
a housing;
a dust box pivotably connected to the housing;
a suction tube slidable into and out of the housing along a longitudinal axis extending in a front-to-rear direction;
a suction head positioned at a forward end of the suction tube and defines a first end of a flow path such that suctioning air is configured to flow into the dust extractor at the suction head;
a tool connection tube supported within the housing, a portion of the tool connection tube protruding from a wall of the housing and extending in the front-to-rear direction parallel to the suction tube;
an outlet positioned at a rearward end of the tool connection tube and defining a second end of the flow path such that suctioning air is configured to flow out of the dust extractor at the outlet; and
a filter positioned along the flow path between the suction tube and the tool connection tube, the filter configured to separate dust and debris from suctioning air traveling along the flow path, wherein the filter is disposed at an oblique angle relative to the longitudinal axis.

15. The dust extractor of claim 14, wherein the suction tube is configured to be extended relative to the housing along an extension direction, and wherein the portion of the tool connection tube that protrudes from the wall of the housing extends parallel to the extension direction.

16. The dust extractor of claim 14, wherein the filter is oriented at a 45-degree angle relative to an extension direction of the suction tube.

17. The dust extractor of claim 14, further comprising a dust box connection tube positioned within the housing between the suction tube and the dust box, the dust box connection tube extending below the suction tube and parallel to the suction tube.

18. The dust extractor of claim 17, wherein the dust box connection tube includes a 90-degree turn at a connection point with the suction tube and a 90-degree turn at a connection point with the dust box.

19. The dust extractor of claim 17, wherein the dust box that supports at least a portion of the filter, and wherein the dust box connection tube directs the flow of air from the suction tube into the dust box.

20. The dust extractor of claim 14, wherein the outlet is a flange that is integrally formed with the tool connection tube at an end of the tool connection tube that is exterior to the housing.
